(19) United States
(12) Patent Application Publication
(10) Pub. No.: US 2026/0204498 A1
(43) Pub. Date: Jul. 16, 2026

(54) MOUSE

(71) Applicant: DEXIN CORPORATION, New Taipei City (TW)

(72) Inventors: HO-LUNG LU, NEW TAIPEI CITY (TW); Tung-Chi Tsai, New Taipei City (TW); Yi-Chen Liu, New Taipei City (TW)

(21) Appl. No.: 19/260,302

(22) Filed: Jul. 4, 2025

Related U.S. Application Data
(60) Provisional application No. 63/745,596, filed on Jan. 15, 2025.

(30) Foreign Application Priority Data
Mar. 25, 2025 (TW) 114111072

(51) Int. Cl. H01H 13/85; H01H 13/52; H01H 13/86

(52) U.S. Cl. CPC H01H 13/85; H01H 13/52; H01H 13/86; H01H 2231/008

(57) ABSTRACT

A mouse includes a housing, two switch modules, and a bottom base. One side of the housing includes a plurality of fixing structures. Each of the two switch modules includes a bottom plate, a micro switch, two screws, and an elastic buffer adjustment component. The bottom plate is fixed to an inner side of the housing through the two screws. The micro switch is disposed on the bottom plate facing toward two action buttons of the housing, and the elastic buffer adjustment component is disposed between the bottom plate and the housing. A spacing between the micro switch and the pressing structure adjacent thereto is changed by adjusting one of the two screws. When the spacing is changed by adjusting one of the two screws, the elastic buffer adjustment component is elastically deformable by being pressed.

### CROSS-REFERENCE TO RELATED PATENT APPLICATION

This application claims the benefit of priority to Taiwan Patent Application No. 114111072, filed on Mar. 25, 2025. The entire content of the above identified application is incorporated herein by reference.

This application claims the benefit of priority to the U.S. Provisional Patent Application Ser. No. 63/745,596, filed on Jan. 15, 2025, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a mouse, and more particularly to a mouse that is suitable for being used as a gaming mouse.

### BACKGROUND OF THE DISCLOSURE

A tactile feedback of a left button or a right button of a conventional gaming mouse (i.e., an e-sports mouse) is extremely important for gamers (e.g., an e-sports player) or other users. However, the conventional gaming mouse does not have a specific design or specification for the tactile feedback of the left button or the right button. Accordingly, even when gamers purchase two gaming mice of a same model, the left buttons (or the right buttons) of the two gaming mice may respective provide a different tactile feedback.

### SUMMARY OF THE DISCLOSURE

In response to the above-referenced technical inadequacy, the present disclosure provides a mouse for improving the conventional gaming mouse and addressing the problem that the left buttons (or the right buttons) of the two gaming mice may respectively provide a different tactile feedback.

In order to solve the above-mentioned problems, one of the technical aspects adopted by the present disclosure is to provide a mouse. The mouse includes a housing, two switch modules, and a bottom base. The housing includes a body and two action buttons, the body includes a plurality of fixing structures, and each of the plurality of fixing structures has a screw hole. The two action buttons are movably connected to the body, and an inner side of each of the two action buttons has a pressing structure. The two switch modules include a bottom plate, a micro switch, two screws, an elastic buffer adjustment component, and a bottom base. The bottom plate has at least two through holes. The micro switch is disposed on the bottom plate. When one of the two action buttons is pressed, the pressing structure abuts against the micro switch adjacent thereto. Each of the two screws is locked with the screw hole of one of the plurality of fixing structures by passing through one of the at least two through holes, the bottom plate is fixed to the body through each of the two screws that is in cooperation with the screw hole of one of the plurality of fixing structures, and the bottom plate is arranged under the two action buttons. The elastic buffer adjustment component is disposed between the bottom plate and one of the plurality of fixing structures, the elastic buffer adjustment component is elastically deformable by being pressed, and the two screws are adjustable to change a compressive deformation of the elastic buffer adjustment component, so as to adjust a spacing between the pressing structure and a switch component of the micro switch. The bottom base is configured to carry a main circuit board, a motion detection module, and a processor disposed thereon, and the bottom base is a component that is independent from the main circuit board, and the micro switch is electrically coupled to the processor through a flexible flat cable or a wire.

Therefore, in the mouse provided by the present disclosure, through a design of the two switch modules, relevant personnel can adjust the spacing between the pressing structure and the switch component of the micro switch in the process of assembling the mouse. In this way, it can be ensured that, when the user purchases the gaming mice of a same model, one of the two pressing buttons (e.g. the left button of the right button) of each of the gaming mice can have an approximately same tactile feedback when pressed.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a mouse according to the present disclosure;

FIG. 2 is a partial schematic exploded view of the mouse according to the present disclosure;

FIG. 3 is a schematic view of a housing of the mouse and a switch module according to the present disclosure;

FIG. 4 and FIG. 5 are partial schematic exploded views of the housing of the mouse from different angles of view according to the present disclosure;

FIG. 6 is a partial schematic exploded view of the housing of the mouse and the switch module according to the present disclosure;

FIG. 7 is a partial schematic cross-sectional view of the mouse taken along line VII-VII of FIG. 1;

FIG. 8 is a partial schematic enlarged view of FIG. 7; and

FIG. 9 is a schematic cross-sectional view of part of the switch module of the mouse according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

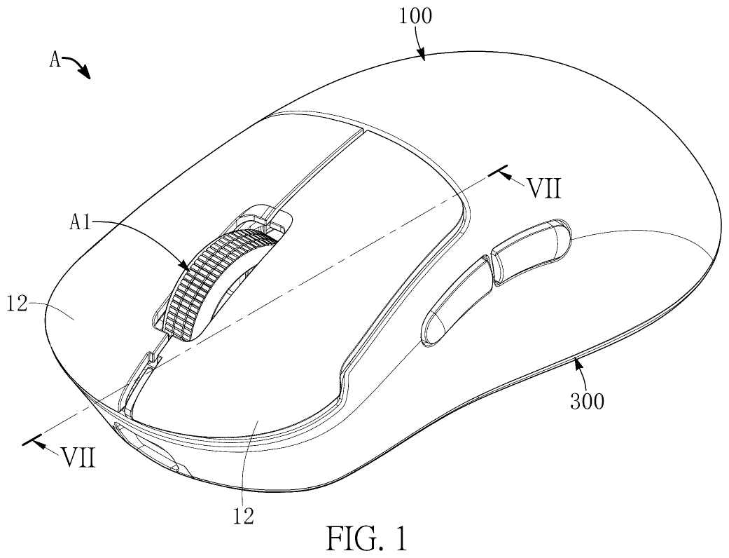

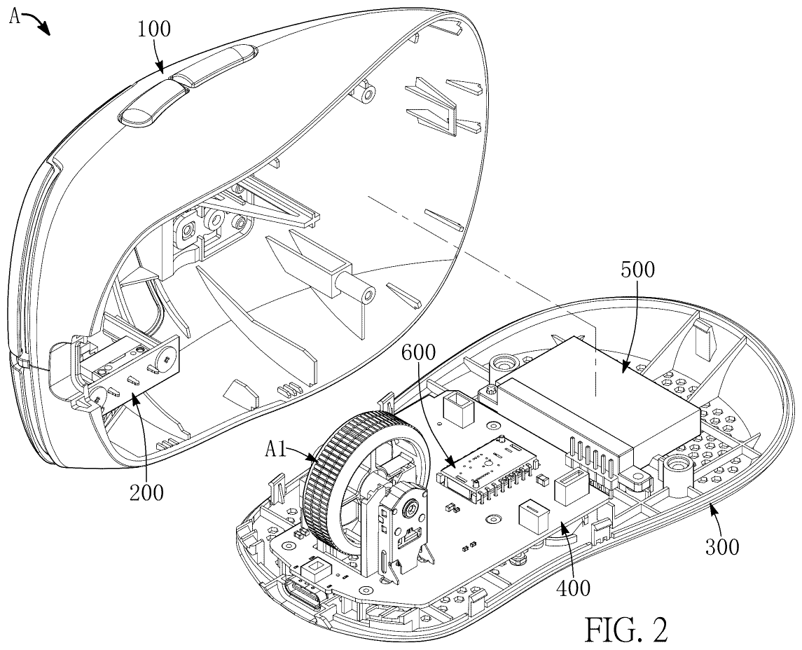

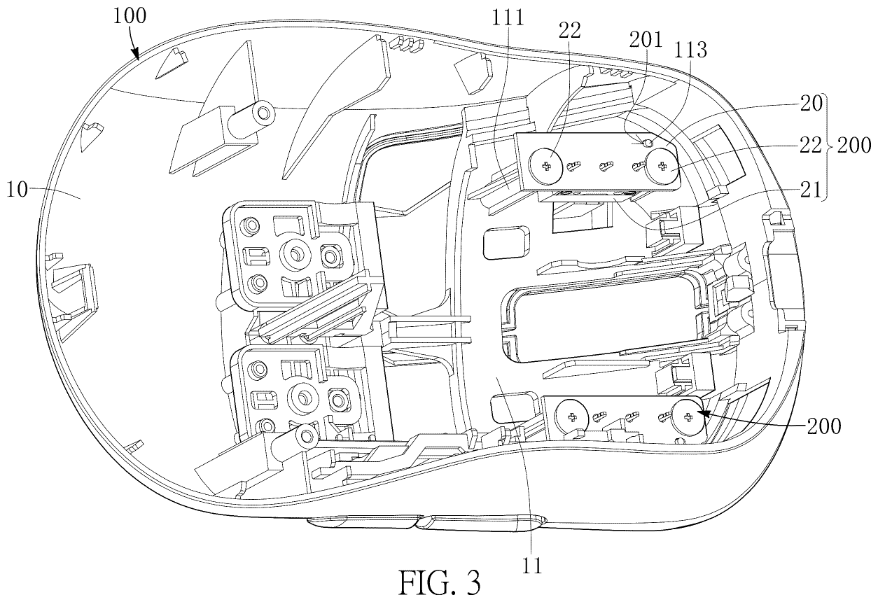

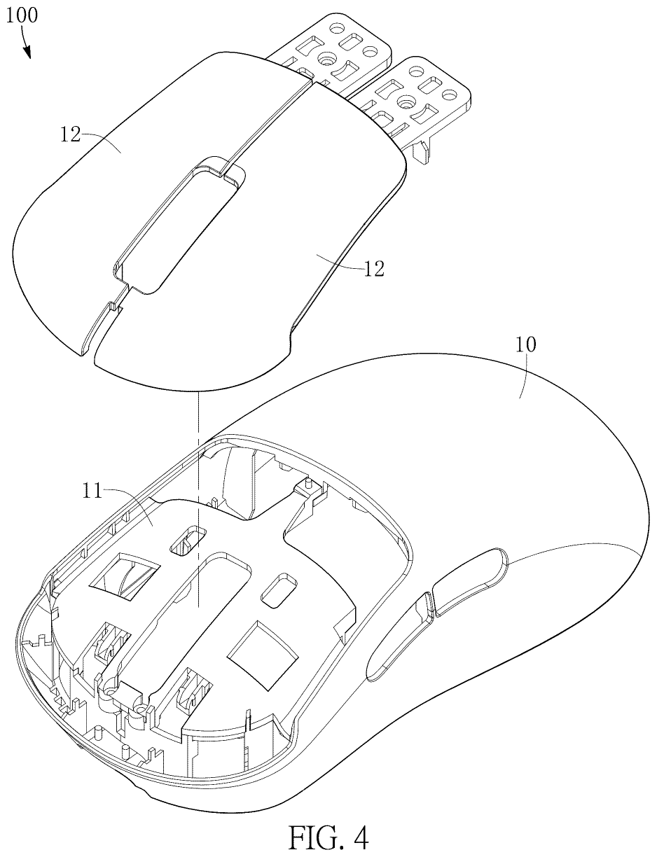

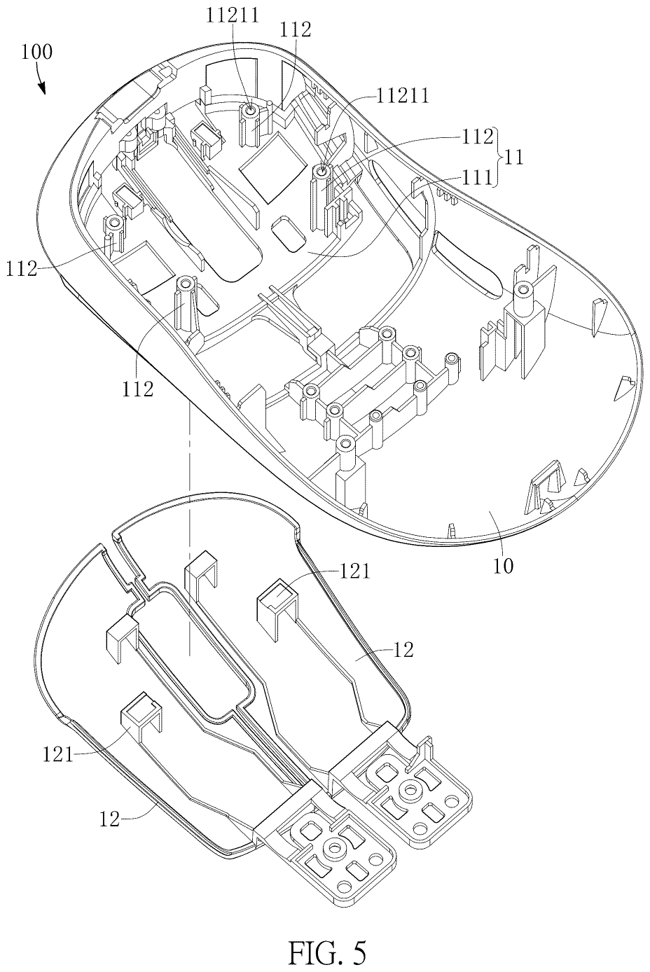

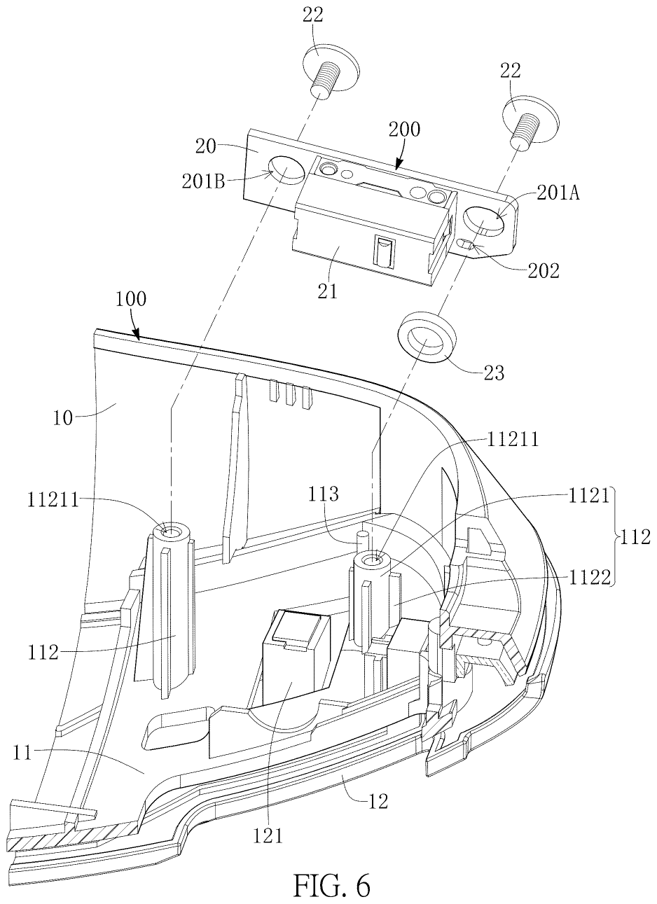

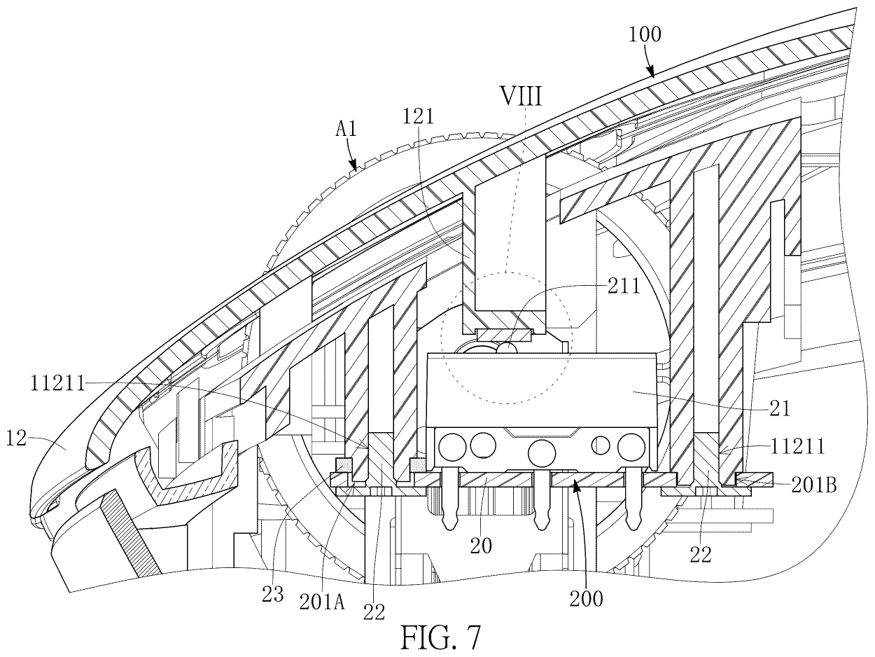

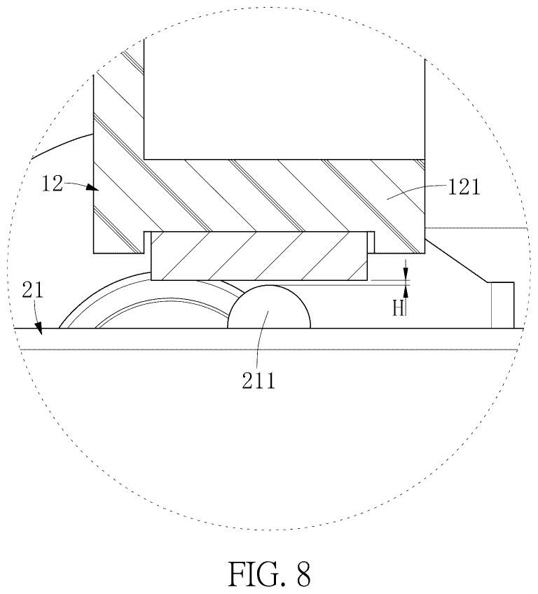

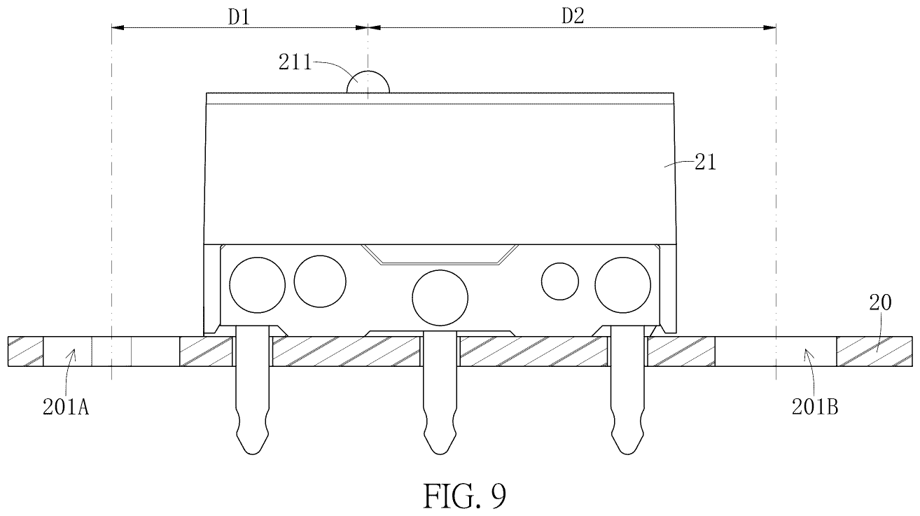

Referring to FIG. 1 to FIG. 8, FIG. 1 is a schematic view of a mouse according to the present disclosure, FIG. 2 is a partial schematic exploded view of the mouse according to the present disclosure, FIG. 3 is a schematic view of a housing of the mouse and a switch module according to the present disclosure, FIG. 4 and FIG. 5 are partial schematic exploded views of the housing of the connector from different angles of view according to the present disclosure, FIG. 6 is a partial schematic exploded view of the housing of the mouse and the switch module according to the present disclosure, FIG. 7 is a partial schematic cross-sectional view of the mouse taken along line VII-VII of FIG. 1, FIG. 8 is a partial schematic enlarged view of FIG. 7, and FIG. 9 is a schematic cross-sectional view of part of the switch module of the mouse according to the present disclosure.

Reference is made to FIG. 1 to FIG. 5, the present disclosure provides a mouse A, which includes a housing 100, two switch modules 200, and a bottom base 300. The housing 100 and the bottom base 300 are detachably connected to each other, the two switch modules 200 are disposed on an inner side of the housing 100, and the two switch modules 200 are arranged in a space defined by the housing 100 and the bottom base 300.

The housing 100 includes a body 10, a supporting structure 11, and two action buttons 12. Specifically, the body 10 of the mouse A is a main structure provided for being held by a user, and the supporting structure 11 is disposed on the body 10. The supporting structure 11 includes a structural body 111 and four fixing structures 112, the structural body 111 is fixed to the body 10, and each of the four fixing structures 112 is formed by extending from a side surface of the structural body 111.

The two action buttons 12 can be movably connected to the body 10, and an inner side of each of the two action buttons 12 has a pressing structure 121. Specifically, the inner side of each of the two action buttons 12 refers to one side of each of the two action buttons 12 facing toward the bottom base 300, and the two action buttons 12 are respectively a left button and a right button. Furthermore, the mouse A includes a scroll wheel A1 disposed between the two action buttons 12.

Each of the four fixing structures 112 includes a column body 1121 (i.e., the four fixing structures 112 respectively include four column bodies 1121), the column body 1121 has a screw hole 11211 disposed on one end of the column body 1121 away from the structural body 111. However, a quantity of the fixing structure 112 of the supporting structure 11 can be adjusted according to practical requirements. Two of the four column bodies 1121 are approximately arranged adjacent to the pressing structure 121 of one of the two action buttons 12, and another two of the four column bodies 1121 are approximately arranged adjacent to the pressing structure 121 of another one of the two action buttons 12.

As shown FIG. 2, the bottom base 300 is configured to carry a main circuit board 400, a motion detection module 500, and a processor 600 disposed thereon. Specifically, a bottom plate 20 is a component that is independent from the main circuit board 400, and each of a plurality of micro switches 21 is electrically coupled to the processor 600 through a flexible flat cable or a wire. The motion detection module 500 is mainly configured to convert a sliding movement trajectory of the mouse A into an electrical signal, so that the processor 600 can transmit the electrical signal to an electronic device (e.g., a computer) along a wire direction or a wireless direction.

As shown in FIG. 3, FIG. 6, and FIG. 8, each of the two switch modules 200 includes a bottom plate 20, a micro switch 21, two screws 22, and an elastic buffer adjustment component 23. For example, the bottom plate 20 can be a circuit board, the bottom plate 20 has at least two through holes (i.e., an adjustment hole 201A and a fixing hole 201B), each of the at least two through holes penetrates through the bottom plate 20, and the micro switch 21 is disposed on the bottom plate 20.

Each of the two screws 22 can pass through one of the at least two through holes, so as to fix to the key hole 11211 of one of the four column bodies 1211 of the supporting structure 11. That is, the bottom plate 20 is fixed to two of the four column bodies 1121 of the four fixing structures 112 of the housing 100 through the two screws 22, and a switch component 211 of the micro switch 21 is arranged under the pressing structure 121 of each of the two action buttons 12.

Specifically, when the left button or the right button of the mouse A is pressed by the user, one of the two action buttons 12 is moved relative to the body 10, and the pressing structure 121 is moved in a direction toward the bottom base 300. The pressing structure 121 of one of the two action buttons 12 that is pressed by the user can abut against the switch component 211 of the micro switch 21 that is adjacent to the one of the two action buttons 12.

The elastic buffer adjustment 23 is arranged between the bottom plate 20 and the supporting structure 11, and the elastic buffer adjustment 23 is elastically deformable by being pressed. Specifically, the two screws 22 can be adjusted to change a compressive deformation of the elastic buffer adjustment component 23, so as to adjust a spacing H (as shown in FIG. 8) between the pressing structure 121 and the switch component 211 of the micro switch 21. In one embodiment, the elastic buffer adjustment component 23 is made of a silicone.

Accordingly, in a process of assembling the mouse A by relevant personnel, the spacing H between the pressing structure 121 and the switch component 211 of the micro switch 21 can be adjusted simply by manipulating each of the two screws 22, so that each of the two action buttons 12 of the mouse A can have an expected tactile feedback.

It should be noted that, when each of the two switch modules 200 is not provided with the elastic buffer adjustment 23, relevant personnel can only adjust the spacing H by adjusting a pitch of each of the two screws 22. However, when each of the two switch modules 200 is provided with the elastic buffer adjustment 23, relevant personnel can adjust the spacing H more precisely through an elasticity of the elastic buffer adjustment member 23.

In one embodiment, when the mouse A is applied in a gaming mouse, the spacing H is within a range from 0 mm to 0.7 mm, a thickness of the elastic buffer adjustment component 23 is within a range from 0.9 mm to 1.1 mm, and the pitch of each of the two screws 22 is within a range from 0.3 mm to 0.8 mm.

In addition, it should be noted that the two switch modules 200 of the mouse A are fixed to the inner side of the housing 100. In a process of assembling the mouse A, after relevant personnel install the two switch modules 200 on the housing 100, relevant personnel can change the spacing H by directly adjusting the two screws 22 instead of adjusting the bottom plate 20. In other words, after relevant personnel install the two switch modules 200 on the inner side of the housing 100, relevant personnel can directly adjust the spacing H by manipulating the two screws 22 instead of needing to wait until the bottom plate 20 is connected to the housing 100. Accordingly, the mouse A of the present disclosure can facilitate the adjustment of the spacing H by relevant personnel.

Based on the above, in a process of producing the mouse A, because the two switch modules 200 of the mouse A of the present disclosure are directly installed on the housing 100, a margin of error of the spacing H can be effectively controlled by only controlling a manufacturing tolerance between the housing 100 and the two switch modules 200. On the other hand, if the two switch modules 200 are installed on the bottom plate 20, the margin of error of the spacing H will be affected, and the manufacturing tolerance of the bottom plate 20 and an assembly tolerance of the housing 100 and the bottom plate 20 will be additionally increased, thereby causing difficulties for relevant personnel to control the margin of error of the spacing H.

As shown in FIG. 6 and FIG. 7, the two through holes of the bottom plate 20 are respectively defined as the adjustment hole 201A and the fixing hole 201B, the adjustment hole 201A is disposed adjacent to the switch component 211 of the micro switch 21, and the elastic buffer adjustment component 23 is arranged between the adjustment hole 201A and the supporting structure 11 adjacent to the adjustment hole 201A. In practice, relevant personnel adjust the spacing H mainly by adjusting one of the two screws 22 adjacent to the switch component 211 (i.e., the one of the two screws 22 in the present embodiment is the screw 22 passing through the adjustment hole 201A), and basically do not adjust another one of the two screws 22 (i.e., the another one of the two screws 22 in the present embodiment is the screw 22 passing through the fixing hole 201B).

In practice, the switch component 211 of the micro switch 21 is disposed adjacent to one end of the micro switch 21, and the switch component 211 is not located in a center of the micro switch 21. Accordingly, in practice, relevant personnel can rapidly install the switch component 211 on a correct position through designs of the bottom plate 20 and the housing 100.

For example, in one embodiment, the supporting structure 11 of the body 10 can further include a first positioning structure 113 disposed adjacent to one of the four fixing structures 112. The bottom plate 20 includes a second positioning structure 202 that can engage with the first positioning structure 113, so as to jointly limit a relative position between the bottom plate 20 and the four fixing structures 112. Specifically, the first positioning structure 113 can be, for example, a column structure, and the second positioning structure 202 can be a through hole. It should be noted that specific shapes and positions of the first positioning structure 113 and the second positioning structure 202 can be designed according to practical requirements, and only one exemplary configuration is shown in the drawings.

In addition, the bottom plate 20 can have other auxiliary marking structures or patterns to assist relevant personnel to quickly and correctly install the bottom plate 20 on the four fixing structures 112. For example, one of four corner portions of the bottom plate 20 can have a design of a cutting angle, and the remaining three corner portions are substantially right angle. Moreover, the bottom plate 20 can be printed with a marking pattern to provide for relevant personnel to identify an installation direction of the bottom plate 20.

In one embodiment, at least one of the four fixing structures 112 includes the column body 1121 and a plurality of ribs 1122, and an outer diameter of the column body 1121 is less than an inner diameter of the adjustment hole 201A. Specifically, the plurality of ribs 1122 are formed on an outer side of the column body 1121, and the elastic buffer adjustment component 23 is a ring-shaped structure that is sleeved on an end of the column body 1121. Moreover, when the two screws 22 and the fixing structure 11 are fixed to each other, the bottom plate 20 and the ribs 1122 can jointly clamp the elastic buffer adjustment component 23. Furthermore, the elastic buffer adjustment component 23 is sleeved at the column body 1121, and one side of the elastic buffer adjustment component 23 is connected to an end of each of the ribs 1122 adjacent to the elastic buffer adjustment component 23 through an adhesion component (e.g., various adhesives or double-sided tape). Accordingly, through the aforementioned designs, in a process of assembling each of the two switch modules 200, relevant personnel can rapidly and simply install the elastic buffer adjustment component 23 on an expected position. In one embodiment, the first positioning structure 113 is formed by extending from one of the ribs 1122 of the supporting structure 11.

As shown in FIG. 9, it should be noted that a linear distance between a center of the adjustment hole 201A and a center of the switch component 211 of the micro switch 21 is defined as a first distance D1, and a linear distance between a center of the fixing hole 201B and a center of the switch component 211 of the micro switch 21 is defined as a second distance D2, and the first distance D1 is less than the second distance D2. In one embodiment, the first distance D1 is less than a half of a length of the bottom plate 20. Accordingly, the spacing H can be easily changed by manipulating one of the two screws 22 that passes through the adjustment hole 201A.

Based on the above, through a design of the two switch modules 200 of the mouse A provided by the present disclosure, in a process of assembling the housing 100 and the two switch modules 200 by relevant personnel, the relevant personnel can directly adjust the spacing H between the pressing structure 121 of each of the two action buttons 12 and the switch component 211 of the micro switch 21, so that a tactile feedback of the two action buttons 12 of a final product of the mouse A can be effectively controlled by manufacturers.

It should be noted that, in practice, an additional testing equipment can be used by the manufacturers to press the left button and the right button of the mouse A with different pressure (e.g., the unit is gram), and records a pressure of the left button and the right button of the mouse A when the micro switches respectively corresponding to the left button and the right button produce signals, thereby obtaining grams of the left button of the mouse A and grams of the right button of the mouse A (i.e., the tactile feedback of the user).

Based on the above, the two switch modules 200 of the mouse A of the present disclosure is fixed to the inner side of the housing 100. Accordingly, after relevant personnel fix the two switch modules 200 to the inner side of the housing 100, the housing 100 installed with the two switch modules 200 can be directly placed in the testing equipment, so as to measure the grams of a corresponding one of the two action buttons 12. Afterwards, relevant personnel can adjust the two screws 22 according to practical requirements, so as to allow the grams of each of the two action buttons 12 to meet expectations.

### Beneficial Effects of the Embodiment

In conclusion, in the mouse provided by the present disclosure, through a design of the two switch modules and the housing, relevant personnel can adjust the spacing between the pressing structure of each of the two action buttons and the switch component of the micro switch by manipulating one of the two screws of each of the two switch modules according to practical requirements in the process of assembling the mouse, thereby effectively controlling the tactile feedback of the left button and the right button when the mouse is manufactured.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A mouse, comprising:
a housing including:
a body including a plurality of fixing structures, wherein each of the plurality of fixing structures has a screw hole;
two action buttons movably connected to the body, wherein an inner side of each of the two action buttons has a pressing structure;
two switch modules each including:
a bottom plate having at least two through holes;
a micro switch disposed on the bottom plate, wherein, when one of the two action buttons is pressed, the pressing structure abuts against the micro switch adjacent thereto;
two screws, wherein each of the two screws is locked with the screw hole of one of the plurality of fixing structures by passing through one of the at least two through holes, the bottom plate is fixed to the body through each of the two screws that is in cooperation with the screw hole of one of the plurality of fixing structures, and the bottom plate is arranged under the two action buttons; and
an elastic buffer adjustment component disposed between the bottom plate and one of the plurality of fixing structures, wherein the elastic buffer adjustment component is elastically deformable by being pressed, and the two screws are adjustable to change a compressive deformation of the elastic buffer adjustment component, so as to adjust a spacing between the pressing structure and a switch component of the micro switch; and
a bottom base fixed to the housing, wherein the bottom base is configured to carry a main circuit board, a motion detection module, and a processor disposed thereon, and wherein the bottom base is a component that is independent from the main circuit board, and the micro switch is electrically coupled to the processor through a flexible flat cable or a wire.

2. The mouse according to claim 1, wherein the spacing is within a range from 0 mm to 0.7 mm, and a thickness of the elastic buffer adjustment component is within a range from 0.9 mm to 1.1 mm.

3. The mouse according to claim 1, wherein the spacing is within a range from 0 mm to 0.7 mm, and a pitch of each of the two screws is within a range from 0.3 mm to 0.8 mm.

4. The mouse according to claim 1, wherein the two through holes of the bottom plate are respectively defined as an adjustment hole and a fixing hole, and the adjustment hole is disposed adjacent to the switch component of the micro switch, wherein the elastic buffer adjustment component is arranged between the adjustment hole and one of the plurality of fixing structures adjacent to the adjustment hole, and wherein a linear distance between a center of the adjustment hole and a center of the switch component of the micro switch is defined as a first distance, a linear distance between a center of the fixing hole and a center of the switch component of the micro switch is defined as a second distance, and the first distance is less than the second distance.

5. The mouse according to claim 4, wherein the first distance is less than a half of a length of the bottom plate.

6. The mouse according to claim 4, wherein at least one of the plurality of fixing structures includes a column body and a plurality of ribs, an outer diameter of the column body is less than an inner diameter of the adjustment hole, the plurality of ribs are formed on an outer side of the column body, and the elastic buffer adjustment component is a ring-shaped structure that is sleeved on an end of the column body, and wherein, when the two screws and the plurality of fixing structures are fixed to each other, the bottom plate and the plurality of ribs jointly clamp the elastic buffer adjustment component.

7. The mouse according to claim 6, wherein the elastic buffer adjustment component is sleeved at the column body, and one side of the elastic buffer adjustment component is connected to an end of each of the plurality of ribs adjacent to the elastic buffer adjustment component through an adhesion component.

8. The mouse according to claim 6, wherein each of the plurality of fixing structures has a first positioning structure extending from one of the plurality of ribs thereof, the bottom plate includes a second positioning structure, and the second positioning structure and the first positioning structure are engaged with each other, so as to jointly limit a relative position between the bottom plate and the plurality of fixing structures.

9. The mouse according to claim 1, wherein the body includes a plurality of first positioning structures disposed adjacent to the plurality of fixing structures, the bottom plate includes a second positioning structure, and the second positioning structure is engaged with one of the plurality of first positioning structures, so as to jointly limit a relative position between the bottom plate and the plurality of fixing structures.

10. The mouse according to claim 1, wherein the elastic buffer adjustment component is made of a silicone.
